(19) United States
(12) Patent Application Publication
(10) Pub. No.: US 2012/0317151 A1
(43) Pub. Date: Dec. 13, 2012

(54) Model-Based Method for Managing Information Derived From Network Traffic

(76) Inventors: Thomas Walter Ruf, Fuerth (DE); Bernhard Fischer-Wuenschel, Weihenzell (DE); Renate Wendlik, Roth (DE)

(21) Appl. No.: 13/157,062

(22) Filed: Jun. 9, 2011

(51) Int. Cl. G06F 17/30; G06F 15/16

(52) U.S. Cl. 707/802; 707/E17.044

(57) ABSTRACT

A network intelligence solution (“NIS”) is arranged to access a stream of IP (Internet Protocol) packets associated with communications over a network between a network access device and a server. The NIS performs deep packet inspection (“DPI”) to extract a volume of information from the accessed stream that conforms to at least one discrimination criteria and further utilizes an evaluation model that applies rules to filter the volume of information to distinguish user-initiated traffic flowing across the network from non-user-initiated traffic. The filtered results are written to a database and may be analyzed to determine network usage and/or other network characteristics.

### BACKGROUND

Communication networks provide services and features to users that are increasingly important and relied upon to meet the demand for connectivity to the world at large. Communication networks, whether voice or data, are designed in view of a multitude of variables that must be carefully weighed and balanced in order to provide reliable and cost effective offerings that are often essential to maintain customer satisfaction. Accordingly, being able to analyze network activities and manage information gained from the accurate measurement of network traffic characteristics is generally important to ensure successful network operations.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A network intelligence solution (“NIS”) is arranged to access a stream of IP (Internet Protocol) packets associated with communications over a network between a network access device and a server. The NIS performs deep packet inspection (“DPI”) to extract a volume of information from the accessed stream that conforms to at least one discrimination criteria and further utilizes an evaluation model that applies rules to filter the volume of information to distinguish user-initiated traffic flowing across the network from non-user-initiated traffic. The filtered results are written to a database and may be analyzed to determine network usage and/or other network characteristics.

In various illustrative examples, a mobile communications network supports portable network access devices such as mobile phones and smartphones to access resources such as web servers on the Internet via a web browsing session that employs a request-response protocol such as HTTP (HyperText Transfer Protocol) or SIP (Session Initiation Protocol). Discrimination criteria such as technical data, page information, or timing-based information are observed by a DPI machine in the NIS when generating the volume of information. The evaluation model applies rules, which may include deterministic rules and rules implementing aggregative evaluation of the discrimination criteria (which can be weighted differently), in various combinations to identify user-initiated requests and corresponding responses from the server. User-initiated request/response pairs identified by the evaluation model are written to the database and non-user-initiated request/response pairs are substantially excluded from the database.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative mobile communication network environment in which the present model-based method for managing information derived from network traffic may be implemented;

FIG. 2 shows an illustrative web browsing session which utilizes a request-response communication protocol;

FIG. 3 shows how responses can be both user-initiated and non-user-initiated and include HTML (HyperText Markup Language) objects and embedded objects;

FIG. 4 shows an illustrative network NIS that may be located in a mobile communications network or node thereof;

FIG. 5 shows an illustrative set of variables that may be output from a deep packet inspection machine and the selection of a subset therein that are utilized as discrimination criteria in the present model-based method;

FIG. 6 shows an illustrative taxonomy of discrimination criteria that may be utilized in the present evaluation model;

FIG. 7 shows an illustrative data flow from the deep packet inspection machine through an evaluation model to produce filtered results which may be used to identify network access device user activities;

FIG. 8 shows a graph depicting an ideal target for the filtered results in which the x-axis represents the share of “true clicks” remaining after filtering and the y-axis represents the share of “true clicks” in the results; and

FIG. 9 shows a flowchart of an illustrative model-based method for managing information derived from network traffic.

Like reference numerals indicate like elements in the drawings. Unless otherwise indicated, elements are not drawn to scale.

### DETAILED DESCRIPTION

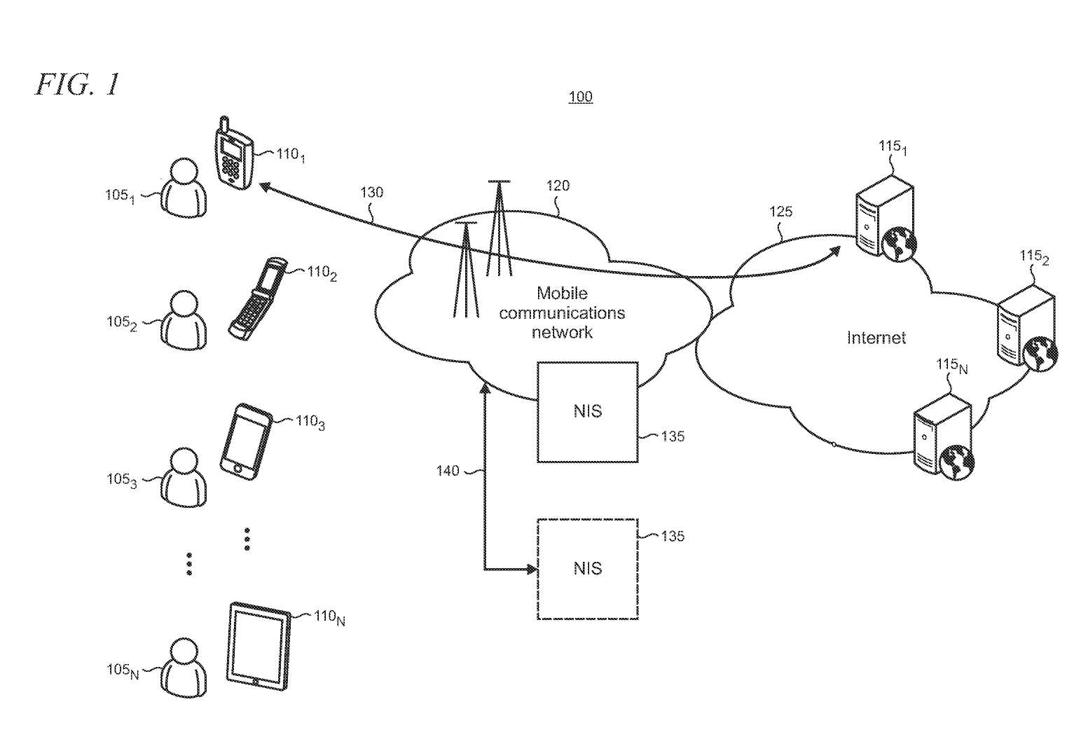

FIG. 1 shows an illustrative mobile communication network environment 100 in which the present model-based method for managing information derived from network traffic may be implemented. It is recognized that effective analysis of network traffic can provide benefits to both network operators and users of the network (i.e., customers) by enabling, for example, the appropriate resources to be invested to ensure optimal utilization of the network's capacity and effective congestion control, while delivering reliable and high quality service and a rich feature set to the network user. In addition, analysis of users' behaviors when accessing resources such as web pages over the network can help network providers, resource hosts, or third parties to tailor services, products, or other offerings that are responsive to the network users' wants and expectations.

As shown in FIG. 1, a number of users 105_{1, 2 . . . N} of respective network access devices 110_{1, 2 . . . N} may access resources provided from various web servers 115_{1, 2 . . . N}. Access is implemented, in this illustrative example, via a mobile communications network 120 that is operatively connected to the web servers 115 via the Internet 125. It is emphasized that the present method for managing information is not necessarily limited to mobile communications network implementations and that other network types that facilitate access to the World Wide Web including local area and wide area networks, PSTNs (Public Switched Telephone Network), and the like that may incorporate both wired and wireless infrastructure may be utilized in some implementations. In this illustrative example, the mobile communications network 120 may be arranged using one of a variety of alternative networking standards such as UMTS (Universal Mobile Telecommunications System), GSM/EDGE (Global System for Mobile Communications/Enhanced Data rates for GSM Evolution), CDMA (Code Division Multiple Access), CDMA2000, or other 2G, 3G, or 4G (2^{nd}, 3^{th}, and 4^{th} generation, respectively) wireless standards, and the like.

The network access devices 110 may include any of a variety of conventional electronic devices or information appliances that are typically portable and battery-operated and which may facilitate communications using voice and data. For example, the network access devices 110 can include mobile phones, e-mail appliances, smartphones, PDAs (personal digital assistants), ultra-mobile PCs (personal computers), tablet devices, tablet PCs, handheld game devices, digital media players, digital cameras including still and video cameras, GPSs (global positioning systems) navigation devices, pagers, or devices which combine one or more of the features of such devices. Typically, the network access devices 110 will include various capabilities such as the provisioning of a user interface that enables a user 105 to access the Internet 125 and browse and selectively interact with web pages that are served by the Web servers 115, as representatively indicated by reference numeral 130.

A network intelligence solution (“NIS”) 135 is also provided in the environment 100 and operatively coupled to the mobile communications network 120, or to a network node thereof (not shown) in order to access traffic that flows through the network or node and apply the present model-based management techniques. In alternative implementations, the NIS 135 can be located remotely from the mobile communications network 120 and be operatively coupled to the network, or network node, using a communications link 140 over which a remote access protocol is implemented.

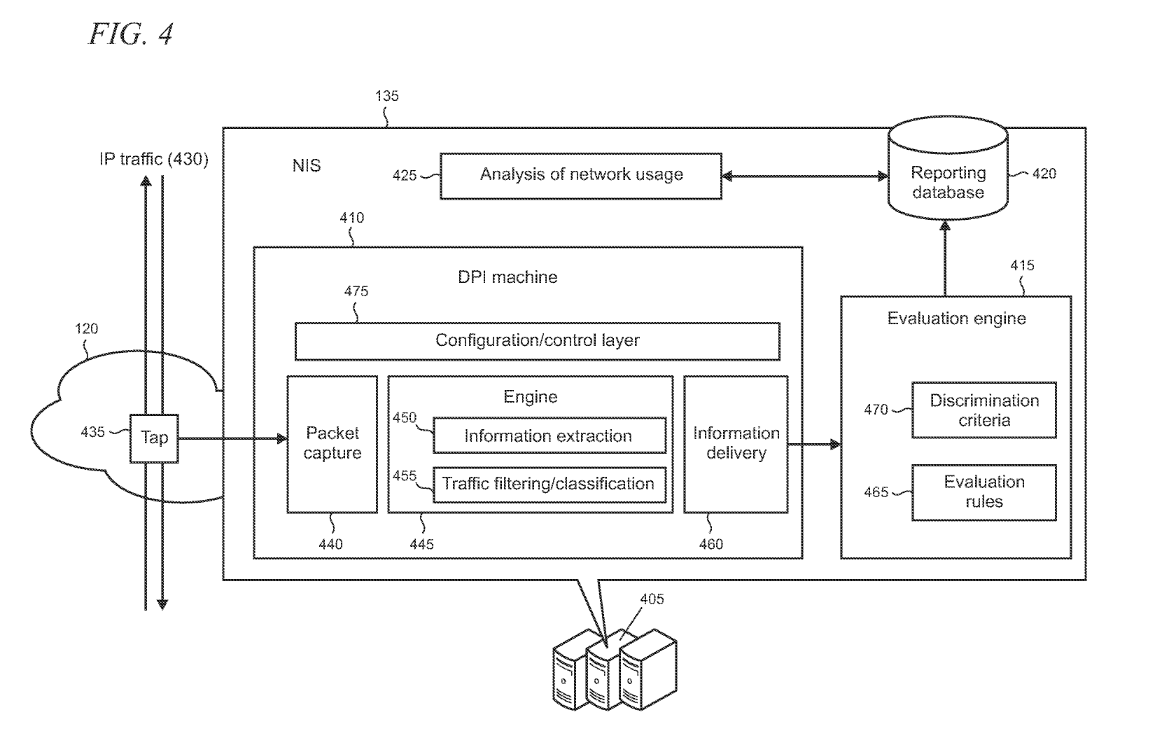

It is noted that performing network traffic analysis from a network-centric viewpoint can be particularly advantageous in many scenarios. For example, attempting to collect information at the client network access devices 110 can be problematic because such devices are often configured to utilize thin client applications and typically feature streamlined capabilities such as reduced processing power, memory, and storage compared to other devices that are commonly used for web browsing such as PCs. In addition, collecting data at the network advantageously enables data to be aggregated across a number of network access devices 110, and further reduces intrusiveness and the potential for violation of personal privacy that could result from the installation of monitoring software at the client. The NIS 135 is described in more detail in the text accompanying FIG. 4 below.

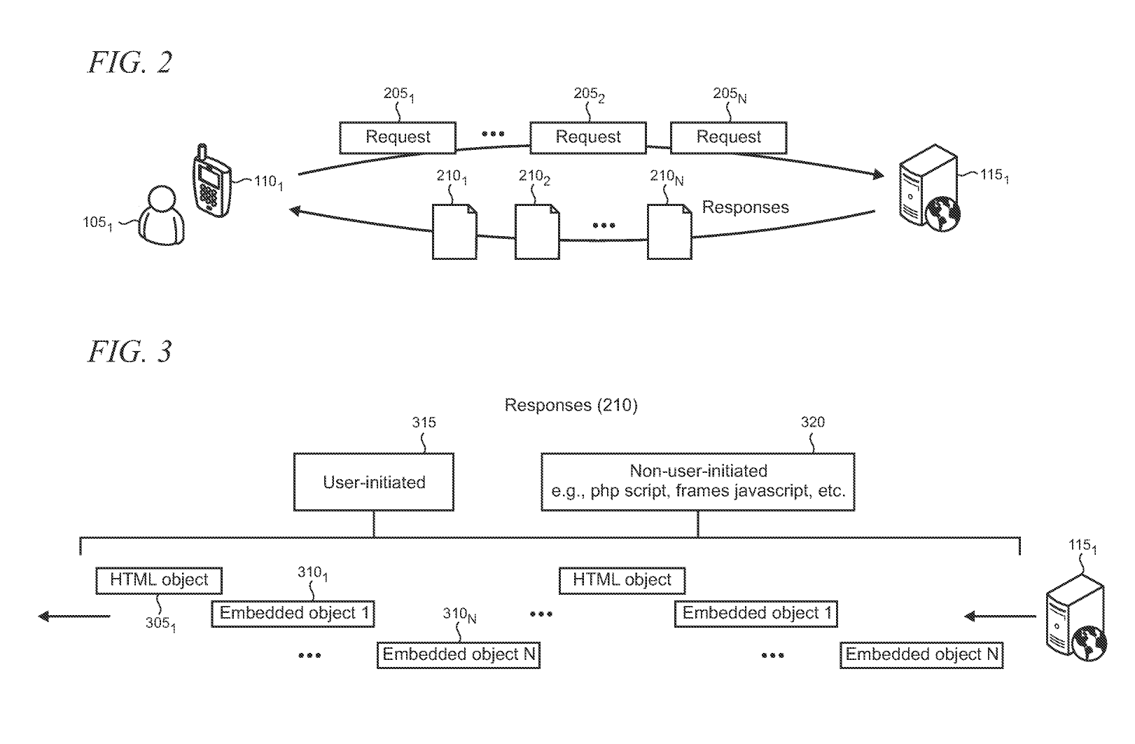

FIG. 2 shows an illustrative web browsing session which utilizes a protocol such as HTTP or SIP. In this particular illustrative example, the web browsing session utilizes HTTP which is commonly referred to as a request-response protocol that is typically utilized to transfer Web files. Each transfer consists of file requests 205_{1, 2 . . . N} for pages or objects from a browser application executing on the network access device 110 to a server 115 and corresponding responses 210_{1, 2 . . . N} from the server. Thus, at a high level, the user 105 interacts with a browser to request, for example, a URL (Uniform Resource Locator) to identify a site of interest, then the browser requests the page from the server 115. When receiving the page, the browser parses it to find all of the component objects such as images, sounds, scripts, etc., and then makes requests to download these objects from the server 115.

As shown in FIG. 3, a webpage is primarily an HTML (HyperText Markup Language) object (representatively indicated by reference numeral 305) typically having a content type of text/html with links to other objects 310_{1 . . . N} in it as embedded objects (images, sounds, scripts, etc.). A webpage may accordingly be generated either in response to a direct user-initiated request (also termed a “true click”), as indicated by reference numeral 315, or due to a non-user-initiated request (also termed a “false click”), as indicated by reference numeral 320 via execution, for example, of an embedded script at the client network access device 110 (FIG. 1). Such script execution can result in a substantial amount of network traffic to be automatically generated and to flow to the network access device 110 through the mobile communications network 120. For example, a visit at the news site CNN.com with 5 page views will create 650 HTTP events in which 100 of them are HTML.

FIG. 4 shows details of the NIS 135 which is arranged, in this illustrative example, to identify user-initiated traffic and distinguish it from non-user-initiated traffic by examining network traffic through the mobile communications network 120. The NIS 135 is typically configured as one or more software applications or code sets that are operative on a computing platform such as a server 405 or distributed computing system. In alternative implementations, the NIS 135 can be arranged using hardware and/or firmware, or various combinations of hardware, firmware, or software as may be needed to meet the requirements of a particular usage scenario.

The NIS 135 comprises a deep packet inspection (“DPI”) machine 410 and an evaluation engine 415 that writes to a reporting database 420. The reporting database 420 may be accessed, manipulated, and queried to perform analysis of the usage of the mobile communications network 120, as indicated by reference numeral 425 in FIG. 4. DPI machines are known, and commercially available examples include the ixMachine produced by Qosmos SA.

As shown, traffic 430 typically in the form of IP packets flowing through the mobile communications network 120, or a node of the network, are captured via a tap 435 in a packet capture component 440 of the DPI machine 410. An engine 445 takes the captured IP packets to extract various types of information, as indicated by reference numeral 450, and filter and/or classify the IP traffic 430, as indicated by reference numeral 455. An information delivery component 460 of the DPI machine 410 then outputs the data generated by the engine 445 to the evaluation engine 415, as shown. The evaluation engine 415 uses various evaluation rules 465 through the application of one or more of the discrimination criteria 470 in various combinations in order to identify user-initiated traffic in the IP traffic 430.

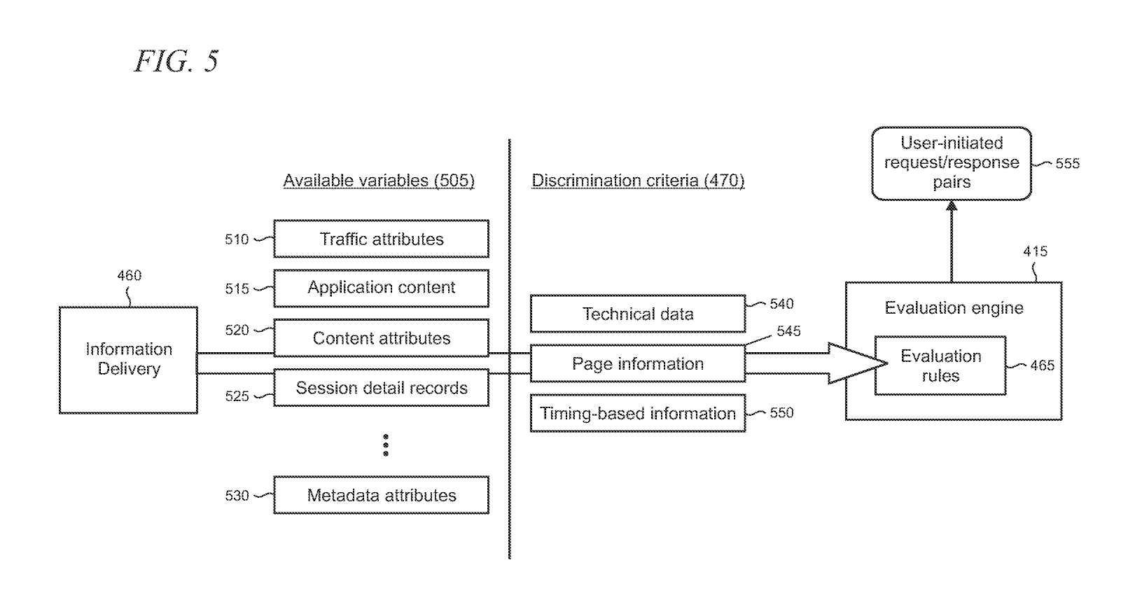

FIG. 5 shows an illustrative set of variables 505 that may be output from the DPI machine 410 (FIG. 4) and the selection of a subset therein that are utilized as discrimination criteria 470 in the present model-based method. As shown, the DPI machine 410 has the capability to produce a very large set of variables that can be captured from the IP traffic 430 (FIG. 4). These variables illustratively include traffic attributes 510, application content 515, content attributes 520, session detail records (“SDRs”) 525, and metadata attributes 530, among other variables. In accordance with the principles of the present model-based method for managing information, it is noted that a particular subset of the myriad of available variables 505 is particularly well-suited for use as discrimination criteria 470. This includes technical data 540, page information 545, and timing-based information 550 which are then applied using the rules 465 in the evaluation engine 415 to identify user-initiated request/response pairs 555.

The selection of the technical data 540, page information 545, and timing-based information 550 may be implemented, for example, by executing the appropriate code in the DPI machine. Turning again to FIG. 4, for example, software code may execute in a configuration and control layer 475 in the DPI machine 410 to select the discrimination criteria from among the variables that are available for output by the DPI engine 445.

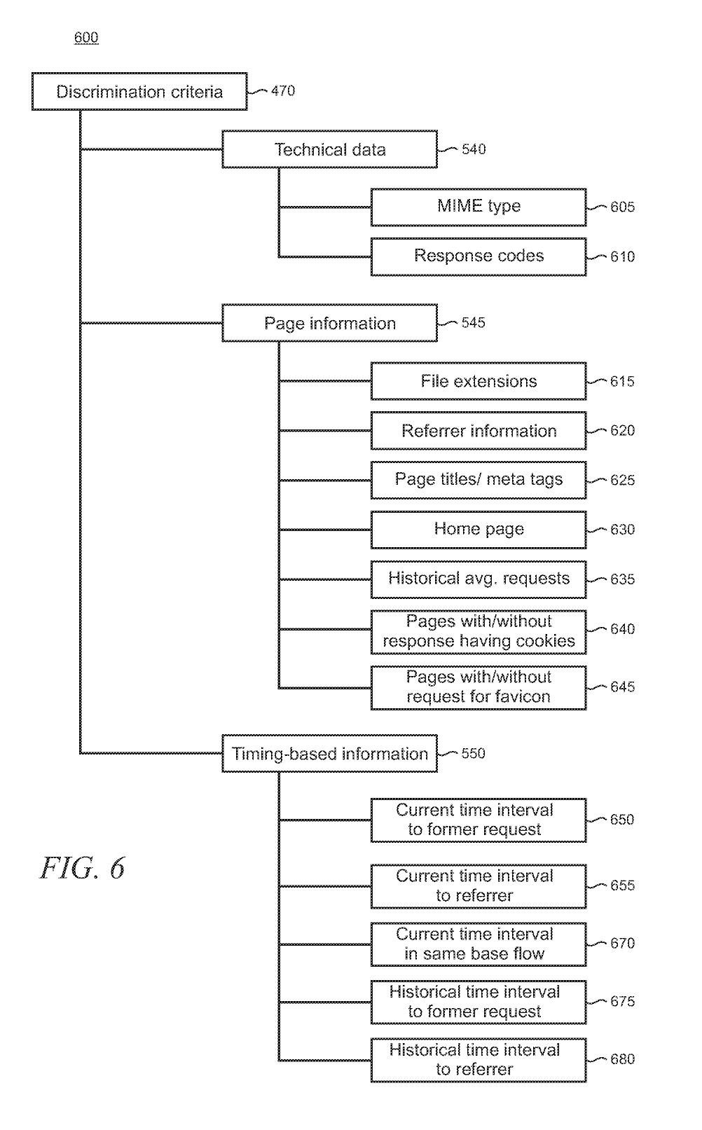

FIG. 6 shows an illustrative taxonomy 600 of discrimination criteria 470 that may be applied by the rules 465 (FIG. 4) in the evaluation engine 415. It is emphasized that the taxonomy 600 is intended to be illustrative of the variables that have been determined to be good candidates to identify user-initiated request/response pairs in many typical applications. However, the variables illustrated in taxonomy 600 should not be viewed as an exhaustive listing of all suitable variables. As shown, the technical data 540 illustratively includes MIME (Multipurpose Internet Mail Extension) type 605 such as text/html, image/jpeg, application/x-javascript, xhtml+xml, and the like. The technical data 540 further includes response codes 610 (i.e., status codes) from a Web server 115 (FIG. 1) where, for example, response codes 200-299 indicate OK, codes 301-304 indicate redirection, and codes 400-999 indicate errors.

The page information 545 illustratively includes file extensions 615 such as .jpg, .bmp, .gif, .htm, .js, etc. Referrer information 620 may include web pages without a referrer (i.e., where a referrer identifies, from the point of view of a webpage, the address or URL of the resource which links to it). The page information 545 may further include page titles and meta-tags 625 where the meta-tags may include, for example, search words, and also includes a URI (Uniform Resource Identifier) to a home page 630. Page information 545 may further include an historical average number of requests 635 that are received at a particular server 115. Variables included in the page information 545 also include pages both with and without a response having cookies (including third-party cookies), as indicated by reference numeral 640, and pages both with and without a request for a favorite icon (also termed a “favicon”), as indicated by reference numeral 645.

The timing-based information 550 illustratively includes the time interval between a current request (e.g., request 205 in FIG. 2) to a former (i.e., preceding) request, as indicated by reference numeral 650. The timing-based information 550 may also include the time interval between a current request and a referrer, as indicated by reference numeral 655.

Under the HTTP 1.1 standard, multiple successive requests may be written out to a single network socket without waiting for a corresponding response from the remote server in a process known as “pipelining.” The requestor (e.g., the browser) then waits for the responses to arrive in the order in which they were requested. The pipelining of requests can result in a significant improvement in page loading times, especially over high latency connections. The time interval between a current request and a request in the same base flow when using the pipelining technique, as indicated by reference numeral 670 may also be included in the timing-based information 550. The timing-based information 550 may further include observations of the history of the time intervals between requests 675, as well as the historical time interval to a referrer 680.

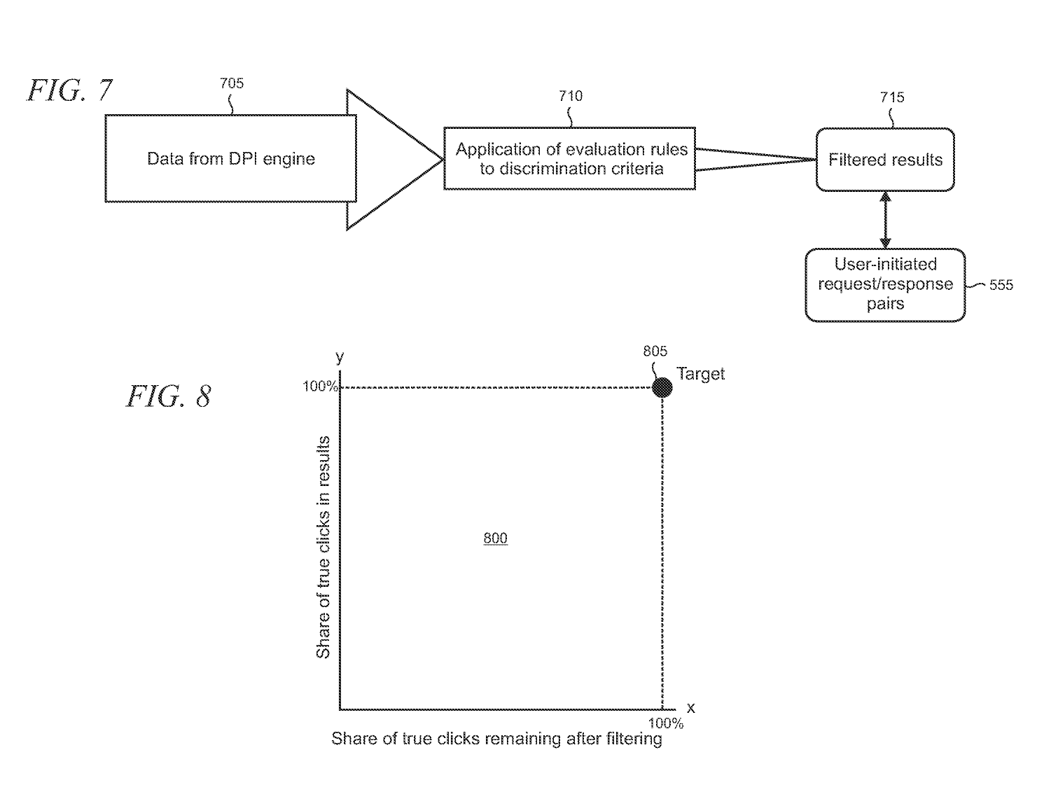

As noted above, the evaluation rules 465 (FIG. 4) are applied to the network traffic using the discrimination criteria 470 in order to identify user-initiated requests and corresponding server responses and further distinguish those requests/responses from non-user-initiated request/response pairs that may be generated, for example, through execution of embedded scripts. In other words, as shown in FIG. 7, data 705 generated from the DPI engine 445 (FIG. 4) is filtered through the application of the evaluation rules to the discrimination criteria, as indicated at reference numeral 710, to produce a set of filtered results 715. The optimal target of such filtering would be a one-to-one correspondence between the filtered results 715 and the user-initiated request/response pairs 555.

FIG. 8 depicts a graph 800 which expresses this target graphically in which the x-axis indicates the share of true clicks remaining after filtering and the y-axis represents the share of true clicks in the filtered results. The target 805 is at 100% on the x-axis and 100% on the y-axis which means that no true clicks are missed (i.e. the filtered results 715 are not under-inclusive of true clicks) and only true clicks are included (i.e., the filtered results are not over-inclusive to include false clicks).

It has been determined that utilization of various evaluation rules 465 (FIG. 4) alone or in various combinations can provide filtered results that can provide satisfactory performance in approaching the target 805. Such evaluation rules may encompass a range of rules and include relatively straightforward deterministic rules as well as more complex rules that utilize, for example, the aggregation of evaluations of a plurality of discrimination criteria (i.e., variables), where the evaluations can be weighted in some cases. The aggregation may be performed, for example, on an additive or multiplicative basis.

For example, a set of illustrative rules can be utilized as follows: Utilization of evaluation rule 1 will include an object in a response in the filtered results if the object is determined to belong to a group MIME type=text/html (or a comparable group such as xhtlm, xml, plain/text, etc.). Evaluation rule 2 will include a response object when a server response code=2xx (i.e., indicating that the corresponding request was successfully received, understood, and accepted). Evaluation rule 3 will exclude an object having a particular file extension such as .jpg., bmp, .gif, .js, and the like. Evaluation rule 4 will exclude an object if the historical time interval to a former request, in 70% of the cases, was less than 0.5 seconds. Application of this set of illustrative rules to a volume of information containing traffic where the true clicks are known yields a result of 75% on the x-axis and 72% on the y-axis in the graph 800.

An example of a more complex rule set illustratively includes an evaluation of an object based on the aggregative evaluation of several discrimination criteria. This rule set relies upon the observation that some MIME types and file extensions are more likely to be associated with user-initiated actions, others are less likely, and some are definitely not associated. In addition, objects without a referrer and objects that are referrers for other objects are more likely to be associated with user-initiated actions. And, objects that appear with a high time interval or show an historically high median time interval are more likely to be associated with user-initiated actions. Here, each subjective weighting is applied (and expressed as points):
+10 if MIME type=text/html; +5 if MIME type=xml; −50 if MIME type=jpg, gig, bmp, etc.
+5 if home page (i.e., HTTP URL path=/)
+5 if a current time interval to former request is above 0.5 sec or +10 if above 2 sec.
+5 if an historical time interval to a former request is on average above 0.5 sec or +10 if above 2 sec.
−10 if the current time interval in the same base flow is below 0.1 sec.
+3 if an object has no referrer and/or is the object is a referrer of other events.
+3 if the object has a title or meta tags
+1 if the object requests cookies and/or favorite icons

Application of this illustrative complex rule set to a volume of information containing traffic where the true clicks are known yields results that vary between 91/55 (percentages on the respective x-axis and y-axis on the graph 800) and 70/85 depending on the particular threshold values used. The complex rule set can be further refined using optimized weighting for a basic data set using standard dummy regression via the expression

$$p = {\sum }_{i = 1}^{n} {b}_{i} * {v}_{i}$$

where p is the probability that an object is associated with a true click, v is the variable discrimination criteria, and b is the weight.

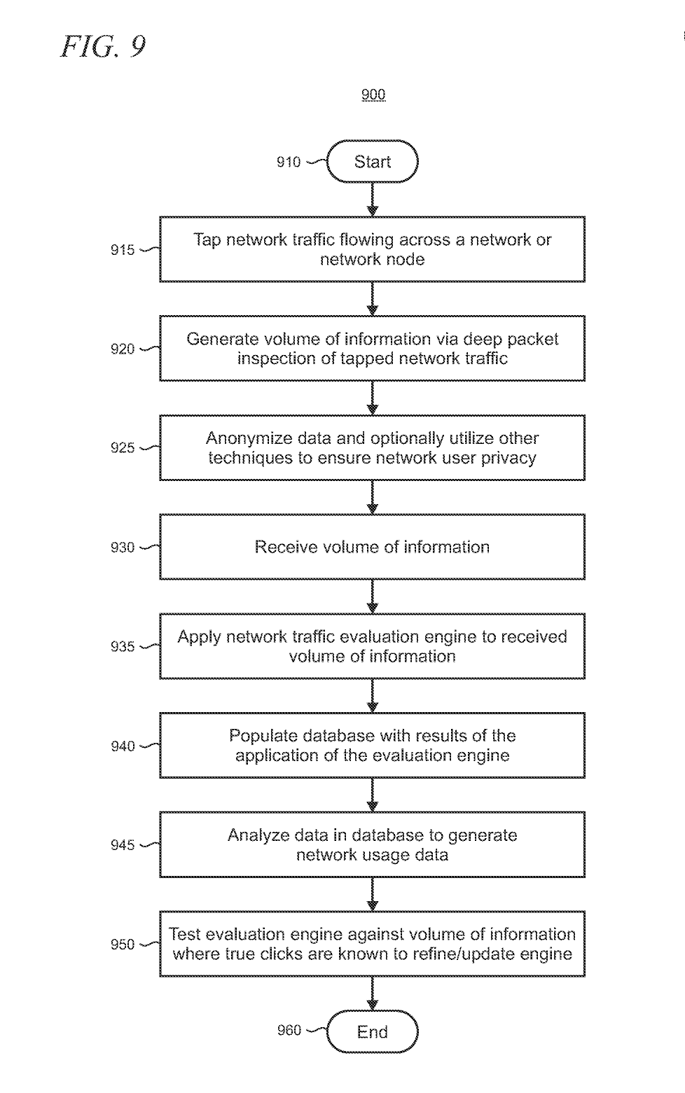

FIG. 9 shows a flowchart of an illustrative model-based method 900 for managing information derived from network traffic. The method begins at block 910. At block 915, traffic flowing across a network or network node is tapped to collect IP packets. A volume of information is generated via deep packet inspection of the tapped network traffic at block 920. At block 925, data utilized by the NIS 135 (FIGS. 1 and 4), or portions thereof can be anonymized to remove identifying information from the data, for example, to ensure that privacy of the network access device users is maintained. It is emphasized that while the method step in block 925 is shown as occurring after block 920, the anonymization described here may generally be included as part of the generation step shown in block 920 or alternatively applied to the captured data at any point in the method 900. Other techniques may also be optionally utilized in some implementations of model-based information management to further enhance privacy including, for example, providing notification to the users 105 that certain anonymized data may be collected and utilized to enhance network performance or improve the variety of features and services that may be offered to users in the future, and providing an opportunity to opt out (or opt in) to participation in the collection.

Anonymization may be implemented by encrypting portions or all of the tapped network traffic to obscure information from which the network access device users' identities or data that could be used to obtain their identities might otherwise be determined. In some cases, the encrypted data may include a unique “anonymizing” identifier that can be correlated to unencrypted traffic data extracted from those packets associated with a corresponding user 105. This anonymizing process allows mobile communications network use of any individual user to be differentiated from the network use of all other users on a completely anonymous basis—that is, without referencing any personal identity information (e.g., name, address, telephone number, account number, etc.) of the user.

The anonymized volume of information is received, at block 930, and a network traffic evaluation engine is applied at block 935. At block 940, the reporting database 420 (FIG. 4) is populated with the filtered results obtained from application of the evaluation engine 415 to the data generated by the DPI machine 410. The data written to the database may include the filtered responses along with the corresponding request (i.e., a request/response pair). The data may then be analyzed to generate mobile communications network usage data, at block 945. Such analysis may be performed by the mobile communications network operator in some cases, or third parties may be provided access to the reporting database 420 in other cases.

At block 950, which may be optionally utilized when needed, the evaluation engine 415 may be tested (on a periodic basis in some instances) against a volume of information in which the true clicks are known. Such testing can be utilized, for example, to refine the evaluation model or update it with different and/or additional rules to improve its performance and get closer to the optimal target (as shown in FIG. 8). The method 900 ends at block 960.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method for managing information derived from network traffic, the method comprising the steps of:
receiving a volume of information derived from a stream of IP packets comprising traffic traversing over a network between a network access device and a server;
applying an evaluation model characterized by at least one variable discrimination criterion for establishing an approximate boundary between responses corresponding to information requests initiated by a network access device user and responses corresponding to non-user-initiated information requests; and
populating a database with information associated with information requests and corresponding responses that satisfy the at least one discrimination criterion specified by the evaluation model, the database excluding a substantial number of information requests which were not the result of an action of the network access device user and further excluding a substantial number of responses corresponding to non-user-initiated information requests.

2. The method of claim 1 further including a step of generating the volume of information by performing deep packet inspection on the stream of IP packets.

3. The method of claim 1 in which a majority of information request/response pairs are excluded from the database by application of the evaluation model.

4. The method of claim 1 including a further step of analyzing data in the database to generate information relating to network usage by users of the network access devices.

5. The method of claim 1 in which the at least one criterion includes a requirement that a file type specified by a response to an information request has a text/html, xhtml, xml, or plain/text extension.

6. The method of claim 1 including a further step of recording a response code within the response to each information request in the volume.

7. The method of claim 6 in which the at least one criterion includes a requirement that a response code corresponding to an information request be 2xx.

8. The method of claim 1 in which the at least one criterion includes a requirement that the file type specified by an information request not have a jpg, bmp, gif, or js extension.

9. The method of claim 1 including a further step of tracking time differences between information requests for sequences of requests from a network access device user.

10. The method of claim 1 including a further step of tracking time differences between an information request and a response to an information request for a sequence of requests from a network access device user.

11. The method of claim 1 including a further step of tracking historical time differences between information requests having at least one shared characteristic in a sequence of pipelined requests from at least one network access device user.

12. The method of claim 11 wherein the at least one shared characteristic includes the MIME type or URI path.

13. One or more computer-readable storage media containing instructions which, when executed by one or more processors disposed in an electronic device implement a network intelligence solution, comprising:
a deep packet inspection machine arranged for tapping a stream of IP packets that traverse a node of a communications network and for extracting information conforming to specified discrimination criteria via deep packet inspection, the IP packets being associated with a web browsing session between a network access device used by a user and a server, the web browsing session utilizing a request-response protocol;
an evaluation model for applying one or more rule sets to the extracted information to identify user-initiated requests and corresponding user-initiated responses from the server and to identify non-user-initiated requests and corresponding non-user-initiated responses from the server; and
a database for receiving user-initiated request/response pairs from the evaluation model, the database being accessible to queries associated with analyses of communications network traffic and being further arranged to substantially exclude non-user-initiated request/response pairs.

14. The one or more computer-readable storage media of claim 13 in which the one or more rule sets contain a single rule or a plurality of rules.

15. The one or more computer-readable storage media of claim 13 in which a rule in the one or more rule sets is a deterministic rule.

16. The one or more computer-readable storage media of claim 13 in which a rule in the one or more rule sets uses aggregative evaluation of each of the discrimination criteria.

17. The one or more computer-readable storage media of claim 16 in which the aggregative evaluation is additive or multiplicative.

18. The one or more computer-readable storage media of claim 16 in which the aggregative evaluation uses weighting of the discrimination criteria.

19. A computer-implemented method for distinguishing between true clicks and false clicks in a web browsing session between a network access device and a remote server, the method comprising the steps of:
configuring a network intelligence solution with access to a communications network that transports IP packets utilized in the session so that the network intelligence solution may tap at least a portion of the IP packets;
applying one more discrimination criteria to the tapped IP packets to extract selected information from the IP packets, the discrimination criteria including at least technical data, page information, or timing-based information; and
using an evaluation model incorporating rules to filter the extracted information to substantially include true clicks and substantially exclude false clicks, the rules being deterministic or implementing aggregative evaluation of each of the discrimination criteria.

20. The computer-implemented method of claim 19 including a further step of applying weighting to the discrimination criteria when implementing the aggregative evaluation.
